(19) United States
(12) Patent Application Publication
(10) Pub. No.: US 2011/0088666 A1
(43) Pub. Date: Apr. 21, 2011

(54) INLINE FUEL PREHEATER AND ATOMIZATION DEVICE

(76) Inventor: Douglas Wayne Puckett, Salversville, KY (US)

(21) Appl. No.: 12/906,044

(22) Filed: Oct. 15, 2010

Related U.S. Application Data
(60) Provisional application No. 61/279,221, filed on Oct. 19, 2009.

(51) Int. Cl. F02M 53/02; F02M 31/02; F02M 29/00

(52) U.S. Cl. 123/557; 123/590

(57) ABSTRACT

An inline fuel preheater and atomization device for an internal combustion engine having a main body including a plurality of sequentially arranged chambers including a first chamber and a final chamber, the chambers separated from each other by inter-chamber barriers having progressively smaller barrier port which enables flow across the device while atomizing the fuel and increasing pressure across the fuel rail. The device is heated by a coil containing a heat transfer fluid drawing heat from a vehicle's mechanical systems around or through which the fluid circulates and subsequently transfers the heat it absorbs to the device and to the fuel flowing through the device.

### CROSS REFERENCE TO RELATED APPLICATIONS

This application claims the benefit of U.S. Provisional Patent Application Ser. No. 61/279,221, entitled TRIPLE CHAMBER FUEL DEVICE, to Douglas W. Puckett, filed Oct. 15, 2009 and incorporated herein by reference.

### BACKGROUND

(a) Technical Field of the Disclosed Embodiments

The disclosed embodiments relate to devices for improving fuel efficiency and reducing pollution caused by the burning of hydrocarbons as a fuel. More particularly, the disclosed embodiments relate to an inline fuel preheater and atomizer for increasing the combustion efficiency of an internal combustion engine.

(b) Problems in the Art

Fuel efficiency for internal combustion engines, such as those in automobiles, is a matter of significant concern. Increased fuel efficiency decreases fuel costs, conserves natural resources, and also reduces pollution associated with burning hydrocarbons. Given the widespread use of internal combustion engines, especially in automobiles and other forms of motorized transportation, any increase in fuel efficiency may have significant economic and environmental impact.

### SUMMARY

The disclosed embodiments describe an inline fuel preheater and atomization device. The device provides increased fuel efficiency by providing the fuel injectors of an internal combustion engine with preheated, atomized fuel. Liquid fuel, such as gasoline or diesel, passes through the main body of the device, where it is heated by proximity to a circulating heated engine coolant, and is forced through a series of sequential ports with respectively decreasing widths. This process converts liquid fuel into a fine spray of microdroplets, referred to in the industry as atomized fuel. Experimental results have indicated that preheating and atomizing fuel increases its combustion efficiency in an internal combustion engine.

### BRIEF DESCRIPTION OF THE DRAWINGS

A better understanding of the in-line fuel preheater and atomization device will be had upon reference to the following description in conjunction with the accompanying drawings, wherein:

FIG. 1 depicts a perspective view of a first embodiment of a main body of an inline fuel preheater and atomization device;

FIG. 2 depicts a fuel outlet end view of the first embodiment of the main body;

FIG. 3 depicts a fuel inlet end view of the first embodiment of the main body;

FIG. 4A depicts a side view of a second embodiment of the main body;

FIG. 4B depicts a fuel outlet end view of the second embodiment of the main body;

FIG. 4C depicts a cross-sectional view of the second embodiment of the main body along lines 4-4 of FIG. 4B;

FIG. 5 depicts a perspective view of an inline fuel preheater and atomization device; and

FIG. 6 depicts a perspective view of an embodiment of a coupling means for securing the main body to a fuel outlet line.

### DETAILED DESCRIPTION OF THE DISCLOSED EMBODIMENTS

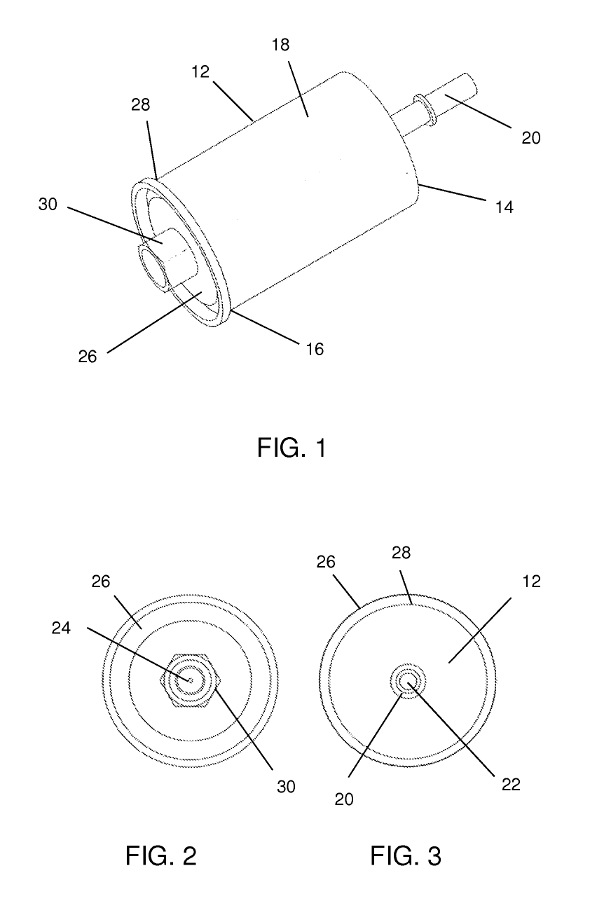

Referring to FIGS. 1-5, the inline fuel preheater and atomization device 10 comprises a sealed main body 12, preferably, but not to the exclusion of other workable geometries, generally cylindrical in shape. The main body 12 includes a first end 14, a second end 16, and an outer wall 18 defining the circumference of the main body 12. The main body 12 also includes a fuel inlet conduit 20 about and extending from a fuel outlet port 24 preferably arranged at the first end 14, and a fuel outlet port 24 preferably arranged at the second end 16. The device 10 is incorporated into a fuel system for an internal combustion engine for a typical automobile, utilizing at least one fuel injector and a fuel pump. The device 10 is incorporated into the fuel system serially between the fuel pump and the at least one fuel injector such that fuel from the fuel pump enters the main body 12 through the fuel inlet conduit 20 and fuel inlet port 22, exits the main body 12 through the fuel outlet port 24, and is returned to the fuel system. The main body 12 is constructed of a material capable of easily conducting heat, preferably aluminum, stainless steel, or similar materials and further capable of resisting corrosion by fuel components.

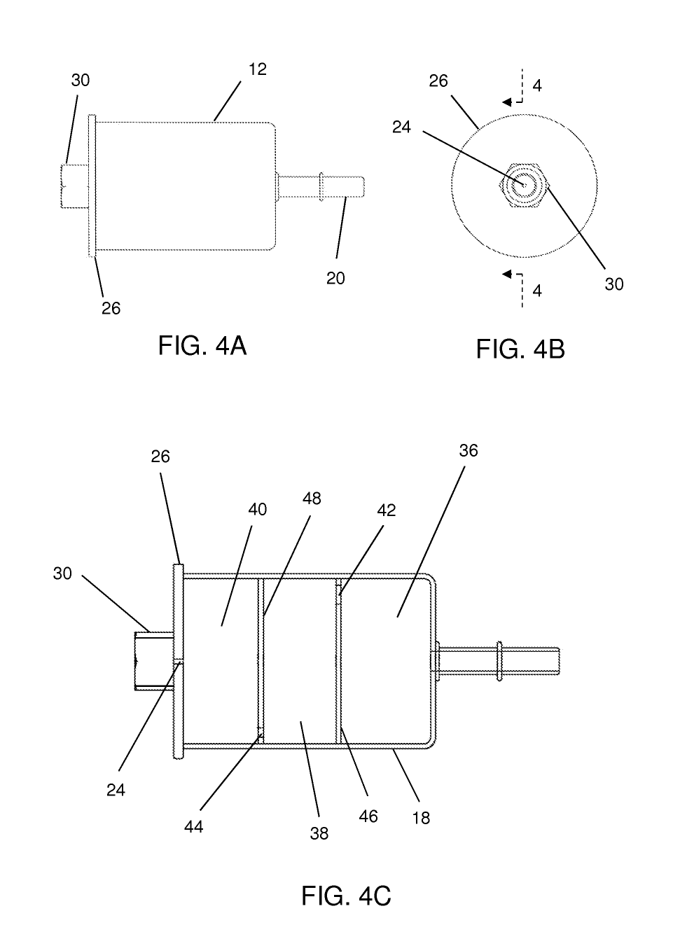

The fuel outlet port 24 is integrated with the second end 16 of the main body 12. Optionally, a cap 26, is secured to the second end 16 of the main body 12 opposite the fuel inlet port 22. The cap 26 may be secured to the main body 12 by any suitable means, such as, for example, welding, clamping, crimping, threaded engagement, or adapting the shape of the cap 26 to accept the main body 12. In a first embodiment shown in FIGS. 1-3 and 5, the cap 26 is adapted to include a main body receiving groove 28 about its circumference which receives the outer wall 18 at the second end 16 of the main body 12. In a second embodiment shown in FIGS. 4A, 4B, and 4C, the cap 26 is welded onto the second end 16 of the main body 12.

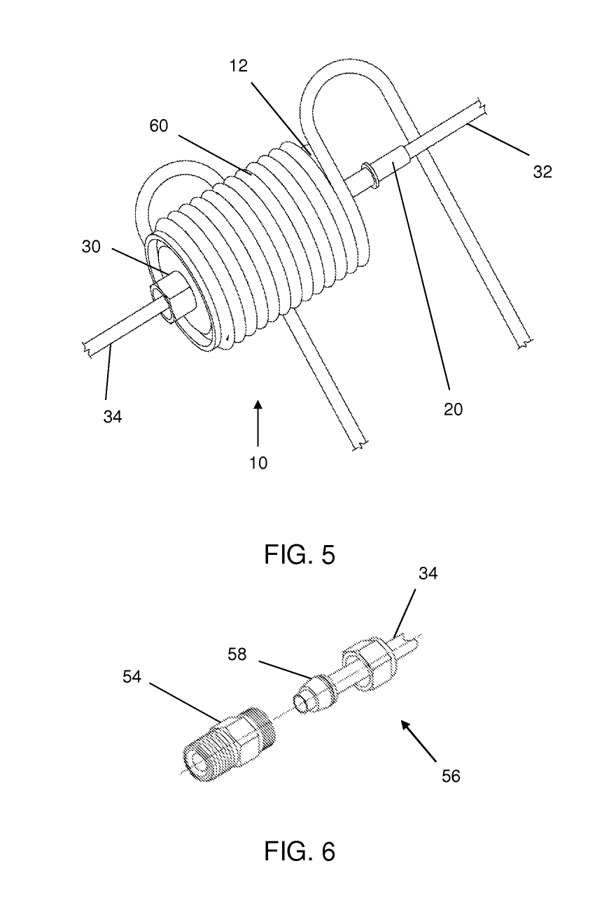

The device is designed to be easily incorporated into the fuel system of an internal combustion engine. In one embodiment, as shown in FIG. 5, the fuel inlet conduit 20 is adapted as a quick connect fitting, such that the fuel inlet line 32 from the fuel pump may be simply inserted into the fuel inlet port 22 and secured via a friction fit and, optionally, a clamp (not shown), a compression fitting (not shown), or similar fastener may be utilized. In one embodiment, where the fuel outlet line 34 to the at least one fuel injector includes a coupling means, such as a threaded coupler 54 and a compression fitting 56 utilizing a ferrule 58 shown in FIG. 6, the second end 16 or alternatively the cap 26 may include a threaded nut 30 about the fuel outlet port 24. The coupler 54 may be screwed into the threaded nut 30 and the ferrule 58 inserted into the coupler 54 to secure the device 10 to the fuel outlet line 34. In another embodiment, as shown in FIG. 5, the fuel outlet line 34 may include a threaded end and may be screwed directly into the threaded nut 30. The threaded nut 30 may be affixed to the second end 16 or cap 26 by welding or other suitable means for attachment. In alternate embodiments, other coupling means may be used to secure the device 10 to the fuel inlet line 32 and fuel outlet line 34.

Referring now to FIG. 4C, the interior of the main body 12 is serially divided into at least a first chamber 36, a second chamber 38, and a third chamber 40. In this embodiment, the third chamber 40 is the final chamber of the main body 12. A first barrier port 42 provides access from the first chamber 36 to the second chamber 38. A second barrier port 44 provides access from the second chamber 38 to the third chamber 40. Alternative embodiments including fourth or further chambers also include additional ports providing access to adjacent chambers. The width of the first barrier port 42 is larger than the width of the second barrier port 44, approximately by a ratio of 2:1. The width of the second barrier port 44 is larger than the width of the fuel outlet port 24, approximately by a ratio of 2:1.

Fuel enters the first chamber 36 via the fuel inlet port 22, passes through the first barrier port 42 into the second chamber 38, passes through the second barrier port 44 into the third chamber 40, and exits via the fuel outlet port 24. The first barrier port 42 and second barrier port 44 are preferably formed at offset locations, as shown in FIG. 4C, such that fuel may not flow in a straight line through the first and second barrier ports 42, 44, but must adopt a serpentine path so as to increase residence time in each chamber and increase pressure, thus improving combustion efficiency upon injection into the combustion chamber.

Referring now to FIG. 5, the device further comprises a heat transfer fluid line 60 surrounding at least a portion of the main body 12. As shown in FIG. 5, the heat transfer fluid line 60 is preferably coiled around the length of the cylindrical-shaped main body 12 and in direct contact therewith to maximize the contact between the heat transfer fluid line 60 and the main body 12. The heat transfer fluid line 60 is preferably fed by a return coolant line associated with the internal combustion engine. The heat transfer fluid line 60 carries coolant; generally a mixture of water and antifreeze. The coolant is heated by the engine, and heat from the coolant is transferred to the heat transfer fluid line 60, and thereby transferred to the main body 12. Heating the main body 12 heats fuel resident within the main body 12. Preheating fuel before it reaches the engine decreases the amount of energy required for the fuel to undergo a phase transition during combustion, which increases the efficiency of fuel combustion. Alternatively, other fluids can be substituted which gain heat from their close proximity to or circulation within mechanical systems. A non-exclusive example of useful fluids are transmission fluids, hydraulic fluids, and engine oil.

The heat transfer fluid line 60 is preferably constructed of a material or materials capable of easily conducting heat, preferably copper, stainless steel, or a similar material. In one embodiment, the heat transfer fluid line 60 is 0.25 inch (0.635 cm) diameter copper tube coiled around the main body 12. The heat transfer fluid line 60 of an additional embodiment includes a pair of quick connect fittings (not shown) or other means for inserting and incorporating the heat transfer fluid line 60 into an existing coolant system associated with an internal combustion engine.

In one embodiment, the main body 12 is substantially a hollow cylinder formed of 0.0625 inch (0.15875 cm) to 0.125 inch (0.3175 cm) thick die cast aluminum with an external diameter of 2.25 inches (5.715 cm) and a length of 3.25 inches (8.255 cm). The main body 12, and hence each of the chambers 36, 38, 40, have an internal diameter of approximately 2.0 inches (5.08 cm). The first chamber 36 has a length of approximately 1.25 inches (3.175 cm). The second chamber 38 and third chamber 40 each have a length of approximately 1.0 inch (2.54 cm).

In this embodiment, the first chamber 36 is separated from the second chamber 38 by a first inter-chamber barrier 46, an approximately 0.0625 inch (0.15875 cm) thick disc with a diameter substantially equal to the inner diameter of the main body 12. The first inter-chamber barrier 46 is preferably constructed of the same material as the outer wall 18, e.g. aluminum, and welded to the interior of the outer wall 18 of the main body 12. The first inter-chamber barrier 46 includes the first barrier port 42 at or in close proximity to the first inter-chamber barrier-outer wall joint 50. The first barrier port 42 has a width of approximately 0.25 inches (0.625 cm), and may be formed by drilling or cutting a hole in the first inter-chamber barrier 46.

In this embodiment, the second chamber 38 is separated from the third chamber 40 by a second inter-chamber barrier 48, a 0.0625 inch (0.15875 cm) thick disc with a diameter substantially equal to the inner diameter of the main body 12. The second inter-chamber barrier 48 is preferably constructed of the same material as the outer wall 18, e.g. aluminum, and welded to the interior of the main body 12. The second inter-chamber barrier 48 includes a second barrier port 44 having a width of approximately 0.125 inches (0.3175 cm), which may be formed by drilling or cutting a hole in the second inter-chamber barrier 48. In this embodiment, the second barrier port 44 is located at or in close proximity to the second inter-chamber barrier-outer wall joint 52. The thickness of the outer wall 18 and the barriers 46, 48 is dependent upon the material utilized.

The fuel inlet conduit 20 is a hollow tube approximately 1 inch (2.54 cm) in length or greater with an inner diameter substantially equal to the width of the fuel inlet port 22. The fuel inlet conduit 20 is joined to the fuel inlet line 32 in a sealed manner so as to permit fuel to flow into the fuel inlet conduit 20 and subsequently flow into the fuel inlet port 22 and the main body 12. Those skilled in the art will understand the several ways the fuel inlet conduit 20 and the fuel inlet line 32 can be joined in a sealed manner, which includes the use of a compression sleeve fitting, compression fitting, welded jacket, or similar means.

The fuel outlet port 24 is an opening in the second end 16 of the main body 12, or in the cap 26 where one is utilized, with a width of approximately 0.0625 inches (0.15875 cm). Guiding fuel serially through ports of decreasing width, namely, the 0.25 inch (0.625 cm) width first barrier port 42, the 0.125 inch (0.3175 cm) second barrier port 44, and the 0.0625 inch (0.15875 cm) fuel outlet port 24, disrupts laminar flow and causes the fuel, at least in part, to separate into microdroplets. There is also a pressure increase across the system due to the disruptions in flow.

The foregoing detailed description is given primarily for clearness of understanding and no unnecessary limitations are to be understood therefrom for modifications can be made by those skilled in the art upon reading this disclosure and may be made without departing from the spirit of the disclosed embodiments of the in-line fuel preheater and atomization device and scope of the appended claims.

What is claimed is:

1. An inline fuel preheater and atomization device for an internal combustion engine comprising:
a main body including
a plurality of sequentially arranged chambers including a first chamber and a final chamber, each said chamber separated from a sequentially adjacent chamber by one of a plurality of inter-chamber barriers, wherein each said inter-chamber barrier possesses at least one barrier port which enables flow across each said inter-chamber barrier;
a fuel inlet port providing access to said first chamber;
a fuel outlet port providing access from said final chamber; and
a heat transfer fluid line surrounding at least a portion of said main body,
whereby a heated fluid in said heat transfer fluid line heats said main body.

2. The device of claim 1, wherein said main body is substantially cylindrical, and includes a first end and a second end.

3. The device of claim 2, wherein said fuel inlet port is arranged at said first end and said fuel outlet port is arranged at said second end.

4. The device of claim 1, further comprising a fuel inlet conduit arranged about and extending from said fuel inlet port.

5. The device of claim 1, wherein said main body is configured to contain the flow of fuel from a fuel inlet line through said fuel inlet port, serially through each said barrier port within and across each said inter-chamber barrier, through said fuel outlet port, then into a fuel outlet line.

6. The device of claim 5, further comprising coupling means for securing said main body to said fuel inlet line and to said fuel outlet line.

7. The device of claim 1, wherein said fuel inlet port, said fuel outlet port and each said barrier port have a width.

8. The device of claim 7, wherein said width of each said barrier port is approximately one half said width of an immediately preceding, upstream said barrier port and approximately twice the width of an immediately following, downstream said barrier port.

9. The device of claim 7, wherein said width of at least one said barrier port is larger than said width of said fuel outlet port.

10. The device of claim 7, wherein said width of at least one said barrier port is smaller than said width of said fuel inlet port.

11. The device of claim 1, wherein said plurality of chambers includes a first said chamber with a volume greater than the individual volumes of each of the remaining said plurality of chambers.

12. The device of claim 1, wherein adjacent said barrier ports are arranged at offset locations.

13. The device of claim 1, wherein said heat transfer fluid line surrounding at least a portion of said main body is coiled around said main body and in direct contact therewith.

14. The device of claim 13, wherein said heat transfer fluid line contains a heat transfer fluid drawn from and returned to a mechanical system that generates heat and the exposure of said heat transfer fluid to said mechanical system causes said heat transfer fluid to become heated.

15. The device of claim 14, wherein said heat transfer fluid line is selected from the group consisting of engine coolant, transmission fluid, hydraulic fluid, and engine oil.

16. An inline fuel preheater and atomization device for improving fuel efficiency in a liquid-cooled internal combustion engine having a fuel system for conveying fuel to said engine and a heat transfer fluid line for conveying coolant, comprising:
a sealed main body including
a plurality of serially arranged chambers separated by individual barriers, each barrier including a barrier port providing access to adjacent chambers;
a fuel inlet port including a width and providing access to a first chamber of said plurality of chambers;
a fuel inlet conduit about and extending from said fuel inlet port; and
a fuel outlet port including a width and providing access from a last chamber of said plurality of chambers, wherein the width of said fuel outlet port is less than the width of said fuel inlet port; and
a heat transfer fluid line surrounding at least a portion of said main body,
whereby fluid in said heat transfer fluid line heats fuel in said main body.

17. A method for preheating and atomizing liquid fuel for a liquid-cooled internal combustion engine having a fuel system for conveying fuel to said engine and a heat transfer fluid line for conveying coolant, comprising the steps of:
a. guiding fuel from a fuel inlet line into a sealed main body, said main body including a plurality of chambers separated by a plurality of inter-chamber barriers and connected by a series of offset barrier ports in said inter-chamber barriers which provide access serially between each of said plurality of chambers, said barrier ports arranged in order of decreasing width;
b. guiding said fuel serially through each of said barrier ports while simultaneously transferring heat to said fuel from a heat transfer fluid line surrounding at least a portion of said main body; and
c. guiding fuel from said main body through a fuel outlet port into a fuel outlet line.
